(19) United States
(12) Patent Application Publication
(10) Pub. No.: US 2026/0366190 A1
(43) Pub. Date: Nov. 19, 2026

(54) SURFACE FINISHING OF OBJECTS

(71) Applicant: STEROS GPA INNOVATIVE, S.L., Barcelona (ES)

(72) Inventors: Francesc GUITART, Barcelona (ES); Pau ROMAGOSA, Barcelona (ES)

(21) Appl. No.: 19/721,351

(22) Filed: Jun. 26, 2026

Related U.S. Application Data
(63) Continuation of application No. PCT/EP2024/088443, filed on Dec. 24, 2024.

(30) Foreign Application Priority Data
Dec. 29, 2023 (EP) 23383402.7

(51) Int. Cl. C25F 7/00; B01J 47/016; C25F 3/16

(52) U.S. Cl. CPC C25F 7/00; B01J 47/016; C25F 3/16

(57) ABSTRACT

According to one aspect an apparatus including a base or container adapted to receive a target object to be surface finished; an electrolyte inlet; at least one electrode; an electrolyte output device for surface finishing that is in fluid communication with the electrolyte inlet, the device including an opening for letting the electrolyte contact the target object when received on the base or in the container, the device being coupled with the at least one electrode; and a moving device configured to provide a relative motion between the device and the target object when received on the base or in the container.

### CROSS-REFERENCE TO RELATED APPLICATIONS

This application relates to and claims the benefit and priority to International Application No. PCT/EP2024/088443, filed Dec. 24, 2024, which claims priority to European Application No. EP23383402.7, filed Dec. 29, 2023, each of which is incorporated herein in its entirety.

### TECHNICAL FIELD

The present disclosure relates to the field of object surface finishing. More particularly, the disclosure relates to apparatuses, assemblies and methods for surface finishing of objects leading to a change in surface condition (such as, e.g., roughness, waviness, gloss, etc.), and it also relates to objects with surfaces finished with such apparatuses, assemblies and methods.

### BACKGROUND

For an adequate operation of certain objects, machines or devices, surfaces thereof may need to be surface finished so that the surfaces meet certain parameters, e.g., a particular shape, a limited rugosity, rounded edges, etc.

Many different surface finishing techniques exist in the art, ranging from mechanical polishing to tribofinishing or electropolishing. Some of these techniques may have to be conducted manually whereas some other techniques may be conducted in an automated manner by means of machines digitally controlled that apply a surface finishing on given objects, and the resulting finished surface meets the given parameters.

Selection of one surface finishing technique over other may be made on the basis of factors such as costs, space requirements, amount of removed material, etc. However, an important factor driving the decision of selecting the surface finishing technique is whether the technique is capable of processing the specific objects to be surface finished. Moreover, it is generally desirable that the resulting surface finishing is isotropic and constant or repeatable through different treatments, which some techniques are not capable of doing, let alone when the surface finishing is manually applied.

Two types of objects that impose limitations on the surface finishing processes that can be used are thin and/or fragile objects, and elongate objects. Thin and/or fragile objects, for example objects with a thickness below 1 centimeter, may be mechanically weak and/or include elements or materials that are prone to failure if they are, e.g., brushed; notwithstanding, the objects may be mechanically weak (i.e., fragile) even when they are not thin. Concerning elongate objects, which may be thin or thicker than 1 centimeter, have the problem of its length when they are to be surface finished. Not many surface finishing machines have dimensions suitable for receiving elongate objects and effectively surface finish them. Manual surface finishing for both types of objects is generally cumbersome and unreliable; lengthy quality control processes may be necessary to make sure that the finishing has been conducted appropriately.

There are several projection systems using electrically conductive free solid bodies as the ion transport element for material removal during surface treatments. For instance, WO 2021/019121 A1 describes a method for smoothing and polishing metals via ion transport using electrically conductive free solid bodies in a projection system. Similarly, WO 2024/105293 A1 outlines a method for smoothing and polishing metals through the projection of electrically conductive free solid bodies. However, these projection methods, assemblies, and systems encounter certain limitations, particularly in scenarios where electrolyte recirculation occurs in an open manner, offering reduced control over the flow of electrolyte in complex geometries. Furthermore, the mechanical integrity of the parts being treated may complicate achieving effective surface treatments.

There is an interest in providing a way of surface finishing objects that reduces or avoids the aforesaid problems, and which is at least capable of processing thin and/or elongate objects, in addition to other objects that are neither thin nor elongate.

### SUMMARY

A first aspect of the disclosure relates to an apparatus. The apparatus may comprise: a base or container adapted to receive a target object to be surface finished; an electrolyte inlet; at least one electrode; an electrolyte output device for surface finishing; and a moving device configured to provide a relative motion between the device and the target object when received on the base or in the container.

The electrolyte output device may be in fluid communication with the electrolyte inlet for the provision of electrolyte on the target object for contact therewith. The electrolyte output device comprises an opening for letting electrolyte contact the target object when the latter is received on the base or in the container.

The device is coupled with the at least one electrode so that electropolishing may be conducted. The electropolishing relies on the provision of electrically charged particles of, for example, the electrolyte so that it can produce ion transport and, therefore, remove metal ions of an object, or exchange metal ions with an object, such as, metal ions of one or more surfaces of the target object. For the electrofinishing to be effective, the target object, or at least the surface thereof to be finished, should be electrically conductive and connected to a first pole, and the electrolyte or particles thereof be electrically conductive such that they have a second pole that is electrically opposite the first pole. The first and second poles, which may or may not be of a same electric source, provide the target object and the electrolyte with a potential difference, owing to, for example, opposite electrical polarities. The electrical polarities may not be the same continuously, for example, the connection of the target object and the device may be such that they are under an alternate current for changing polarities.

As the electrolyte passes through the electrolyte output device, particularly a conduit thereof that acts as a passageway for electrolyte, the electrolyte gets electrically charged. Upon contacting an electrically charged surface of the target object, a potential difference is provided due to different electric potentials being present (e.g., the target object is electrically connected to a pole and has opposite electrical polarity) and the electrolyte takes metal ions from the respective surface, thereby removing material therefrom and, thus, surface finishing it. The particles of the electrolyte are to flow through the electrolyte output device and the at least one opening such that they are in contact with one another or they are close to one another even if they are apart so that an electrical bridge may be formed between the electrolyte output device and the surface of the target object. The electrical bridge makes the ion exchange process, in particular the ion extraction process from the target object, particularly effective owing to the electrical circuit formed therebetween. In this sense, the at least one opening, a density or amount or volume of electrolyte, and a distance between the electrolyte output device and the surface of the target object to be surface finished may be adjusted to form or enhance the formation of the electrical bridge (i.e., greater packing factor of the electrically conductive particles of the electrolyte to have a denser quantity of particles between the two ends of the electrical bridge to be formed).

The electrolyte output device may be configured in such a way that the electrolyte contacts the surface of the object to be finished with more or less particles, and/or with more or less speed, and/or with larger or smaller footprint on the surface. Each of these configurable output conditions allows adaption of the surface finishing process to the particularities of the surface or target object. By way of example, for mechanically weaker objects or surfaces, the density of particles and/or the speed with which the particles reach the surface may be lower to reduce the load exerted on the surface in terms of pressure. By way of another example, for sturdy objects, the density of particles and/or the speed may be greater so as to increase the velocity at which the surface finishing is conducted, thereby reducing the total time to effect the surface finishing.

The particles of the electrolyte may just barely contact the surface of the object to conduct surface finishing, which is especially convenient for weaker parts, and then keep flowing either within the electrolyte output device or on the target object until the particles exit the device and/or the target object. The particles of the electrolyte could likewise contact the surface with more pressure, and then keep flowing either within the electrolyte output device or on the target object until the particles exit the device and/or the target object.

While the particles stay in contact with the surface of the object and the electrical connection exists, the particles may keep removing metal ions owing to the ion exchange until they become saturated of metal ions, or until they lose their metal ion extraction capability owing to factors such as, e.g., loss of porosity of the particles, high temperature of the particles, etc. Upon repeated, either continuous or sequential, provision of electrolyte through the electrolyte inlet allows maintaining the electrolyte flow for repeated surface finishing, and do so alleviating any possible limited metal ion extraction due to the capacity of each particle of the electrolyte that is to remove material from the surface. Owing to how the apparatus is configured and how the electrolyte contacts the target object, the surface finishing attained by the apparatus may be homogeneous or substantially homogeneous throughout the at least one surface of the target object.

The base may be any surface that allows holding and supporting target objects thereon, for example, a flat or a curvilinear sheet or block or conveying belt. The container is a closed recipient that may contain the target object and, possibly, electrolyte that is to be outputted thereto. The container may include one or multiple openings; the inner chamber of the container may remain confined while the one or multiple openings are blocked, either partially or completely.

In the context of the present disclosure, surface finishing may encompass leading to a change in surface condition such as, e.g., roughness, waviness, gloss, etc., on one or more surfaces of a target object to be surface finished. Consequently, surface finishing may encompass one or more of: smoothing of the one or more surfaces, polishing of the one or more surfaces, precision finishing of the one or more surfaces, rounding of the one or more surfaces, deburring of the one or more surfaces, providing corrosion resistance to the one or more surfaces, electrodeposition or coating to the one or more surfaces etc. Further, the electrolyte may include substances known in the art for electropolishing, for example, resins and ion exchange resins.

In some embodiments, an electrolyte used in aspects and embodiments of the present disclosure comprises a solid-particle based electrolyte, including solid particles retaining a liquid electrolyte making them electrically conductive, referencing certain aspects of WO 2017/186992 A1, which is herein incorporated by reference. The environment allocated on an interstitial space between the solid bodies can include a moderation fluid, either a conductive and a non-conductive fluid, miscible or immiscible in the conductive solution retained by the solid bodies, or any possible combination of said mentioned aspects, as mentioned on the previously referenced publication, and in combination to aspects referenced on WO 2022/123096 A1, which is herein incorporated by reference. In some examples, a moderation fluid present on the interstitial space between the solid bodies is to be understood as any fluid, either gas, liquid, superfluid or any other possible fluid presenting a lower electrical conductivity of that presented by the electrically conductive solid particles.

In some examples, free conductive solid particles are applied in diverse forms, such as gel-like or microporous structures, to optimize fluid exchange and enable precise surface modification. These solid bodies may incorporate functional groups, including chelating or acidic groups, which interact selectively with metal ions during polishing processes. For certain implementations, the solid bodies include ion exchange resins, which can be either cationic or anionic and vary in strength, tailored to the intended application.

These conductive particles, composed of materials such as chelating resins, acidic cationic resins, or anion exchange resins, are designed to facilitate efficient metal ion exchange. Materials like sulfonated divinylbenzene (S-DVB) styrene copolymers are particularly advantageous due to their resistance to oxidative conditions and acidic environments. Functional groups such as carboxylic, sulfonic, or chelating groups are integrated into these particles to promote metal ion retention and selective interaction with transition metals, according to application with application number EP 24382307.7, disclosing the use of polarizable chemical substances on the environment of the solid bodies of a particle-based electrolyte for moderating its galvanic interaction with the surface to be treated by interposing a resistive layer between said surface and said solid bodies, herein incorporated by reference.

The particles may adopt various geometries, including spherical, cylindrical, pyramidal, or rhomboidal shapes, and can encapsulate electrolytes tailored to the surface finishing requirements. Encapsulated electrolytes may include solutions of acids such as methanesulfonic, hydrofluoric, sulfuric, citric, or phosphoric acids in concentrations ranging from 0.1% to 70% by weight. The porous or gel-like configurations of these particles enhance their ability to exchange fluids and establish effective surface contact, ensuring meticulous control over surface roughness and other finishing attributes.

Additionally, the system accommodates a wide array of electrolytes, including, water and aqueous solutions of sulfuric acid, methanesulfonic acid (MSA), chlorohydric acid, phosphoric acids, ionic liquids, deep eutectic solvents, and inorganic or organic salt solutions. In some embodiments, the electrolyte liquid incorporated within the solid-particle based electrolyte is selected according to WO 2020/09970 A1, WO 2020/099699 A1, WO 2019/145588 A1 and WO 2023/067214 A1, disclosing the use of conductive liquids comprised within the solid bodies including sulfonic acids, chlorohydric acids, sulfuric acids and water respectively, herein incorporated by reference. This versatility provides users with the flexibility to select from any existing liquid electrolyte, supporting a broad spectrum of electropolishing applications.

The moderation fluid described in this invention may include various components such as water, oils, fatty acids, glycerol, isopropanol, and aliphatic hydrocarbon chains ranging from C5 to C25, as well as polyethylenic substances. It also allows for the combination of these elements with additional compounds like surfactants or fatty alcohols, forming emulsions that alter the resulting properties and expand the fluid's functionality.

Depending on the specific application, the interstitial spaces between solid particles can be filled with non-conductive fluids such as silicone oils, hydrocarbons, or mineral oils. To further enhance the system's effectiveness, other components may be added, including abrasive particles, surfactants, or moderator particles. These additives help reduce surface tension, improve material removal efficiency, and prevent excessive wear during polishing operations.

Moreover, interstitial fillers may include substances like glycols, fatty acids, sulfoxides, ethoxylated alcohols, sulfonic surfactants, or deep eutectic solvents. These additional elements enhance the system's overall performance, offering improved control over surface properties and adapting to various surface finishing requirements.

In some embodiments, the apparatus further comprises a controller for adjusting a proportion between the solid-particle based electrolyte and the moderation fluid to control one or more of: the fluidity of the electrolyte, a recirculation ability of the electrolyte, a mechanical stress applied to the target object being treated, or a combination thereof.

In some embodiments, the apparatus further comprises a displacement device configured to adjust a distance between the opening and the target object when received on the base or in the container.

The distance between the outlet and the target object can be regulated to modify how particles of the electrolyte reach the surface of the target object. Accordingly, by adjusting such distance, more or less particles can reach the surface at once or per period of time, and at greater or lower speed. Hence, the surface finishing process can be configured according to the target objects to be processed, or be dynamically tuned depending on the evolution of the process. Concerning the latter, the distance may for instance adjusted from a first distance to a second distance when the surface finishing is to, e.g., first remove more material in a coarser way, and then remove less material in a more careful way to provide the surface with a smoother surface.

In some embodiments, the electrolyte output device comprises a flexible member and/or a porous member, and the flexible member and/or the porous member are/is arranged on the at least one opening to at least partially block the exiting of the electrolyte towards the base or container.

Such member/s may influence how the particles of the electrolyte contact the surface of the target object.

The member/s may likewise assist in keeping particles of the electrolyte within the device after contacting the surface of the target object, in particular when the device is configured to reduce the number of outputted particles on the target object that might then remain on the target object or the base or container for some time before exiting the apparatus. Therefore, when the particles are to be kept within the device, the particles may keep flowing therewithin through one or more conduits, either in a looped fashion in which particles then again reach the at least one output, or in a disposable fashion in which the particles eventually exit the electrolyte output device through an electrolyte outlet for disposing of the electrolyte, either temporarily (e.g., it may be recycled in the present surface finishing process at a later stage) or permanently (e.g., the electrolyte is not to be recycled).

In some embodiments, the displacement device is configured to adjust the distance such that the distance may at least range between 1 to 10 electrolyte particle housings, and/or between 0.1 mm to 20 mm, in particular between 0.2 mm to 5 mm, and more in particular between 0.2 mm and 2.0 mm.

In some embodiments in which the apparatus comprises the container, the container comprises a plurality of openings with at least first and second openings. The first opening is coupled with the at least one opening of the device, and the second opening is for letting electrolyte exit the container.

The container is configured in such a way that it allows keeping electrolyte therewithin while being in contact with one or more surfaces of the target object for some time. Then, after some time that may be controlled by adjusting parameters of the surface finishing process conducted by the apparatus, particles of the electrolyte may be made to exit the container through the second opening (and/or further opening/s since the plurality of openings may include three, four or even more openings).

The second opening is coupled, in some cases, with the electrolyte output device as well, particularly with a conduit thereof adapted to recirculate or extract the particles therefrom through an electrolyte outlet. In some cases, the second opening is coupled with a conduit or a drain external to the electrolyte output device that enables recycling or disposal of the electrolyte exiting the container. For example, the electrolyte may then be supplied or pumped back to the electrolyte inlet of the apparatus for further surface finishing, either after waiting for some time so as to let the particles cool down if necessary, or after subjecting them to a recycling process that regenerates the particles. Alternatively, the electrolyte may, for example, be stored for some other purpose.

In some embodiments, the apparatus further comprises a conditioning station interposed between the electrolyte inlet and outlet. The conditioning station is preferably configured to keep the electrolytic conditions constant, such as for instance a temperature thereof, a chemical composition thereof, a water content thereof, and/or a solid/liquid ratio thereof. The station allows for a repetitive result over the different treatment cycles and parts that were unavailable up to previous existing processes up to date. In several embodiments, the conditioning station comprises at least one sensor to analyze properties or conditions of the electrolyte, such as a pH sensor, temperature sensor, conductivity sensor, humidity sensor, dielectric permittivity sensor. In some embodiments, the conditioning station comprises a conditioning tank adapted with means for adjusting the electrolyte surface finishing conditions, for example to desired surface finishing conditions, before reintroducing the electrolyte through the electrolyte inlet to a closed chamber housing the part to be polished.

In some embodiments, the apparatus further comprises at least one blocking device. The at least one blocking device may at least partially block the second opening (and/or further opening/s).

Such blocking may preclude direct exiting of particles of the electrolyte through the second opening while the electrolyte is contained within the container. It may be convenient for the surface finishing process to let the particles of the electrolyte stay in contact with the target object for some time within the container, or to generate a packed distribution of particles so that an electrical bridge can be formed or enhanced, or for letting other particles reach the surface to be surface finished.

While inside the container, the number of particles may keep growing and increasing the pressure therein. The at least one blocking device, which may comprise, for example, one or more brushes or other flexible devices, may block the egress of the electrolyte while there is not enough pressure inside that exerts a predetermined load on the blocking device/s. When there is enough pressure, the force of the electrolyte presses against the blocking device/s and they overcome the resistance thereof, thereby, e.g., elastically deforming, moving, etc., the blocking device/s, in turn enabling a passageway for the exit of the electrolyte. With lower pressure, the blocking device/s may return to its/their original configuration that blocks the exit of the electrolyte.

In some embodiments, the device is arranged as a bridge over the base.

A bridge-like arrangement may be particularly convenient for the surface finishing of mechanically weaker objects.

In some embodiments the apparatus further comprises at least one electrolyte outlet. The device is in fluid communication with the at least one electrolyte outlet. The device may be arranged such that electrolyte flows from the electrolyte inlet to the at least one opening, and from the at least one opening to the at least one electrolyte outlet.

A single conduit or a plurality of conduits may be arranged for the flowing of the electrolyte within the device such that, after surface finishing the surface of the target object, the electrolyte can reach the outlet for recycling or disposal of the electrolyte.

In some embodiments, the moving device comprises a conveying device for conveying the target object or the base or container.

Conveyance of the target object, either directly (i.e., the device moves the target object) or indirectly (i.e., the device moves the base or container and, as a result, the target object arranged thereon or therein), enables the surface polishing of different parts thereof with an electrolyte output device that may remain static.

The conveyance may be such that the surface finishing is carried out while there is no movement, i.e., the conveyance halts for the surface finishing of the surface, or while there is movement, i.e., the conveyance is maintained while surface finishing of the surface is carried out.

In some embodiments, the moving device comprises a rotation device for rotating the target object.

Some target objects, such as, for example but without limitation, chains, may have portions thereof not readily accessible for surface finishing thereof. For example, in the case of chains, the chain links are typically in contact with one another, thereby precluding the surface finishing in the contacting portions between the links. Notwithstanding, the not readily accessible portions may become accessible by manipulating the object, which is something that a machine or a person may do after the object has been surface finished and reach an unfinished portion because of the blocking that particular portions during the surface finishing.

The rotation device, which may be any suitable rotation device known in the art, forces a rotation of a portion or the entirety of the target object. With the rotation, changes in positions of portions thereof may take place and, in turn, enable access to portions otherwise inaccessible.

By operating the rotation device selectively, the surface finishing can be conducted on more portions of the surface of the object, or even the entirety of the surface of the object. For example, in the case of chains, the rotation usually repositions the chain links such that different parts of the surface of a chain link come into contact with that of another chain link, and so on. It is to be noted that chains are a mere example of a target object; the scope of the present disclosure also encompasses other target objects.

In some embodiments, the apparatus further comprises a holding device for holding the target object.

In some embodiments, the apparatus further comprises an electric source coupled with the at least one electrode.

A same electric source can be used by the electrolyte output device and the target object to provide the particular electrical connectivity to both for electropolishing. In some other examples, the electrical connectivity is achieved with multiple electric sources.

In some embodiments, the apparatus further comprises comprising the electrolyte.

In some embodiments, the apparatus or the electrolyte output device further comprises at least one cooling circuit.

In some embodiments, the apparatus further comprises the target object to be surface finished.

In some embodiments, the target object is a target object as described in relation to the fourth aspect below.

In some embodiments, the at least one electrode comprises a first electrode and a second electrode. The device may be coupled with the first electrode, and the target object may be coupled with the second electrode. The first electrode and the second electrode have opposite electrical polarities.

In some embodiments, the apparatus further comprises a conduit at least in fluid communication with the electrolyte inlet and the at least one opening. The conduit, which directs the flow of electrolyte throughout the apparatus, may be closed and enable a recycling flow in which electrolyte that has contacted the surface of the target object and has continued within the device is then recirculated and reach the at least one opening again for electropolishing.

In some embodiments, the apparatus comprises a plurality of electrolyte output devices in fluid communication one another.

A set of surface finishing stations can be arranged for the electropolishing of one or multiple target objects in parallel, either simultaneously or in staggered fashion (i.e., one or more stations surface finish the target object while one or more other stations do not surface finish the target object). When a single target object is to be electropolished, the different stations may surface finish different portions of said target object.

When multiple stations are arranged, one or multiple conduits may be provided for the circulation of shared or separate electrolyte in the different stations. Likewise, the electrolyte inlet may be shared between the stations, or multiple electrolyte inlets may be arranged for independent supply of electrolyte to each station or subset of stations.

The base or container, and the moving device, may also be shared or pluralities thereof be arranged for independent surface finishing of each station or subset of stations.

A second aspect relates to an assembly comprising a plurality of apparatuses as described in relation to the first aspect sharing the base or container. The electrolyte inlet of the plurality of apparatuses may be shared or the assembly comprises two or more electrolyte inlets of the apparatuses.

The assembly may provide a multiplicity of surface finishing apparatus that may work as surface finishing stations.

A third aspect relates to a method of surface finishing a target object. The method may comprise: arranging the target object on a base or in a container; and making an electrolyte flow through a conduit of an apparatus from at least one electrolyte inlet to at least one opening adjacent to the arranged target object so that the electrolyte contacts at least one surface of the target object.

At least when the electrolyte contacts the at least one surface, the target object has or is electrically connected to a first electrical polarity, and the conduit or a surface surrounding the at least one opening has or is electrically connected to a second electrical polarity. The first electrical polarity is electrically opposite the second electrical polarity.

One or more surfaces of the target object get surface finished by way of contact of a stream of electrically charged electrolyte particles, which produce electropolishing.

The target object to be surface finished may be any that can be introduced in the container or be supported by the base. Both the container and the base may be shaped and dimensioned according to the target objects to be surface finished.

In some embodiments, making the electrolyte flow further comprises making the electrolyte flow from the at least one opening to at least one electrolyte outlet.

At least part of the stream of electrically charged electrolyte particles can be circulated towards one or more electrolyte outlets for the exiting of the particles, for instance for recycling or disposal thereof.

The at least one electrolyte outlet may be arranged within the apparatus, for example by extending the conduit or providing another conduit or set of conduits that routes the stream towards the at least one electrolyte outlet. Additionally or alternatively, the at least one electrolyte outlet may be formed in the container or between the base and the apparatus. That is to say, in some embodiments, making the electrolyte flow further comprises making the electrolyte flow from the target object to one or more openings between the apparatus and the base, or to one or more openings of the container to let at least some electrolyte exit the apparatus.

A housing of the apparatus may be arranged adjacent to the base to form an inner chamber between the two, and one or more portions in which the base contacts the housing a gap may be provided to form the at least one electrolyte outlet.

In some embodiments, each of the one or more openings is at least partially blocked by a blocking device, such as, e.g., a brush, a flexible device, an elastically deformable device, etc.

In some embodiments, the method further comprises moving the target object and/or the apparatus are/is during contacting of the electrolyte with the at least one surface.

In some embodiments, the method further comprises rotating the target object during contacting of the electrolyte with the at least one surface.

In some embodiments, the target object is a target object as described in relation to the fourth aspect below.

In some embodiments, the method is carried out with an apparatus as described in relation to the first aspect, or with an assembly as described in relation to the second aspect.

A fourth aspect relates to a target object surface finished with a method according to the third aspect.

In some embodiments, the target object has a thickness smaller than 1 cm, more in particular, smaller than one or more of the following values: 1 mm, 600 μm, 20 μm, 10 μm and 5 μm. In some embodiments, the thickness is equal to or greater than 1 μm.

The target object may be, for example but without limitation, a printed circuit board or a layer thereof, a wafer or a conductor or semiconductor sheet or layer or substrate thereof, a plate (including microporous and/or microperforated plates), a battery anode or cathode, a sheet of a capacitor or an ultracapacitor, a spool of an alloy or a metal (e.g., stainless steel, copper, brass, titanium, silver, etc.), etc.

In some embodiments, the target object has a length greater than 6 m.

The target object may be, for example but without limitation, a chain with a plurality of chain links, a bar having a regular or irregular cross-section (e.g., circular, polygonal, star-shaped, etc.), a cable, etc.

### BRIEF DESCRIPTION OF THE DRAWINGS

To complete the description and in order to provide for a better understanding of the disclosure, a set of drawings is provided. Said drawings form an integral part of the description and illustrate embodiments of the disclosure, which should not be interpreted as restricting the scope of the disclosure, but just as examples of how the disclosure can be carried out. The drawings comprise the following figures:

FIG. 1 shows, from a side view, part of an apparatus in accordance with some embodiments.

FIGS. 2 and 3 show, in a cross-section view, variants of electrolyte output devices of apparatuses in accordance with some embodiments.

FIGS. 4, 5, 6 and 7 show, in a cross-section view, variants of electrolyte output devices of apparatuses conducting surface finishing in accordance with some embodiments.

FIGS. 8 and 9 show an apparatus or an assembly in accordance with some embodiments.

FIGS. 10A and 10B show, in a frontal and lateral cross-section views, respectively, a variant of an electrolyte output device for extrusion-shaped samples geometries, in accordance with some embodiments.

### DETAILED DESCRIPTION

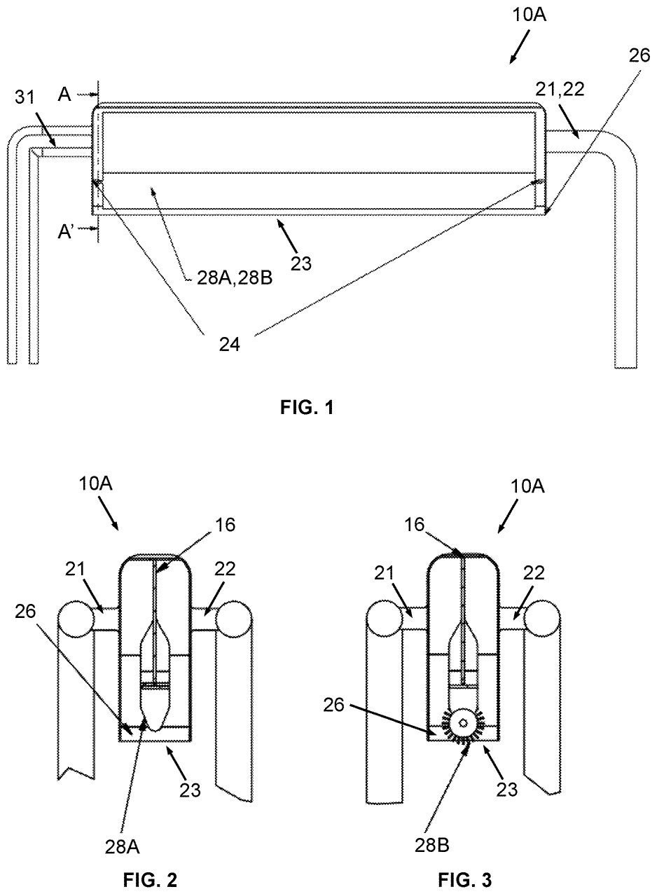

FIG. 1 shows, from a side view, part of an apparatus in accordance with some embodiments.

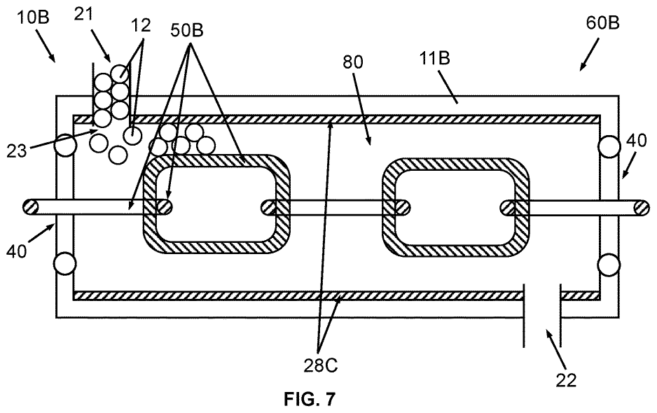

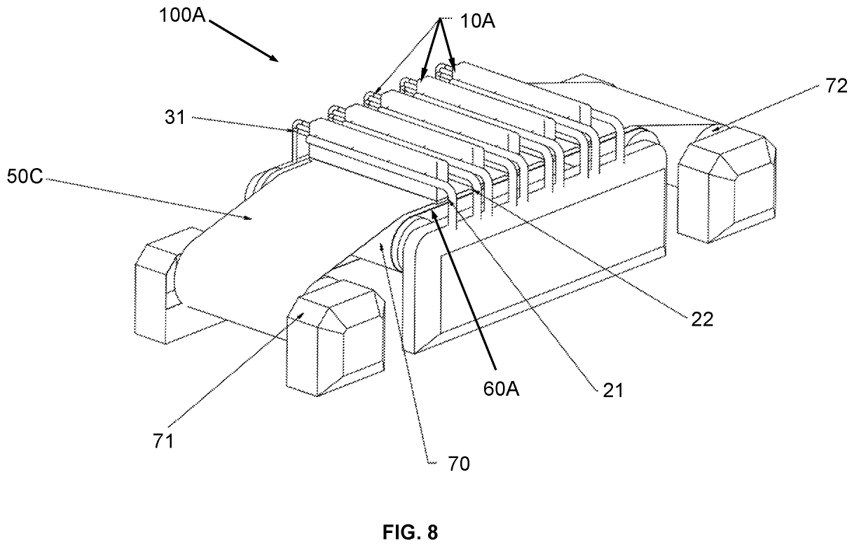

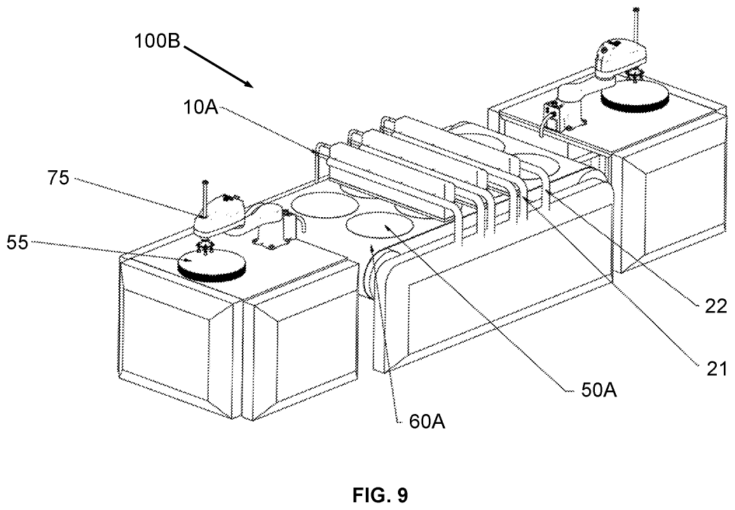

The apparatus includes a base or container (for example, container 60B shown in FIG. 7, or base 60A shown in FIGS. 8 and 9) on which a target object can be arranged for surface finishing. The apparatus also includes an electrolyte inlet 21, and optionally an electrolyte outlet 22, one or more electrodes 28A, 28B, and an electrolyte output device 10A.

The electrolyte output device 10A, which is configured to surface finish one or more target objects, is in fluid communication with the electrolyte inlet 21 through, for example, a conduit arranged at least extending between the electrolyte inlet 21 and an opening 23 that, in some examples, is partially or completely covered by, e.g., a flexible device such as a flexible gasket, that may be porous for the transportation of electrolyte; in some other examples, the opening 23 is not covered. One or more gaskets 24 may be arranged in the device 10A, for example in an inner part thereof and adjacent to a housing of device 10A, for containing the electrolyte therewithin and for avoiding short-circuits due to potential electrical contact with surfaces of the device 10A that could be electrically charged.

Electrolyte can reach a target object arranged adjacent to the opening 23 and, thus, surface finish one or more surfaces of the target object owing to the action of the electrolyte. To this end, the electrolyte is electrically charged by the electrical contact with electrically charged surfaces of the device 10A, such as the one or more electrodes 28A, 28B, which are directly or indirectly coupled with at least one electrical source. The target object to be surface finished should likewise be coupled with at least one electrical source (the same as that used by the device 10A or one or more different ones) to provide the surface or surfaces to be surface finished with the opposite polarity to that of the device 10A and, thus, opposite to that of the electrolyte.

The device 10A also includes a moving device (for example, conveying means 70 shown in FIG. 8) that produces relative motion between the device 10A and the target object to be surface finished, at least while the target object is arranged on the base or in the container.

The electrolyte output device 10A or the apparatus also includes, in some examples, at least one cooling circuit 31 that goes through it, and particularly goes through and/or adjacent to an electrode of the electrolyte output device 10A. The at least one cooling circuit 31 removes heat caused by the electric current supplied for the electropolishing process and the flow of electrolyte. Inlet and outlet cooling conduits are arranged for the cooling, and which may conduct a cooling liquid or gas. Extraction of heat may be convenient for increasing the current that the electrolyte output device 10A may withstand during the electropolishing and/or for increasing the useful life of the electrolyte.

The operation of the electrolyte output device 10A is described in more detail with reference to the following figures.

FIGS. 2 and 3 show, in a cross-section view, variants of electrolyte output devices 10A of apparatuses in accordance with some embodiments. The cross-section is taken through the plane corresponding to the projection of arrowed-lines A-A′ in FIG. 1.

The device 10A of FIGS. 2 and 3 both have an electrolyte inlet 21 and an electrolyte outlet 22. The electrolyte outlet 22 is, in some examples, coupled with the electrolyte inlet 21 or a conduit through which the electrolyte flows and reaches an opening 23 of the device 10A such that a loop is formed for recirculation of the electrolyte. In some other examples, the electrolyte outlet 22 is coupled with an external device or apparatus for the extraction, disposal or recycling of used electrolyte.

The device 10A of FIG. 2 includes a shock electrode 28A for the electrical charging of the electrolyte, whereas the device 10B of FIG. 3 includes a rotary brush electrode 28B for the electrical charging of the electrolyte. It will be noted that other electrodes are possible as well without departing from the scope of the present disclosure. The electrodes 28A, 28B may be electrically coupled with at least one electrical source through, e.g., an electrical contact or wire 16.

Electrolyte may be routed, via a conduit, from the electrolyte inlet 21 to, in this case, the electrolyte outlet 22 passing through the opening 23 through which the electrolyte comes into contact with one or more surfaces of a target object.

Some parameters of the surface finishing process can be adjusted for adapting the process to the particularities of the target object, the moving device, and the electrolyte. For example, the amount or volume of electrolyte to reach the target object can be adjusted by way of a distance between the opening 23 and the target object.

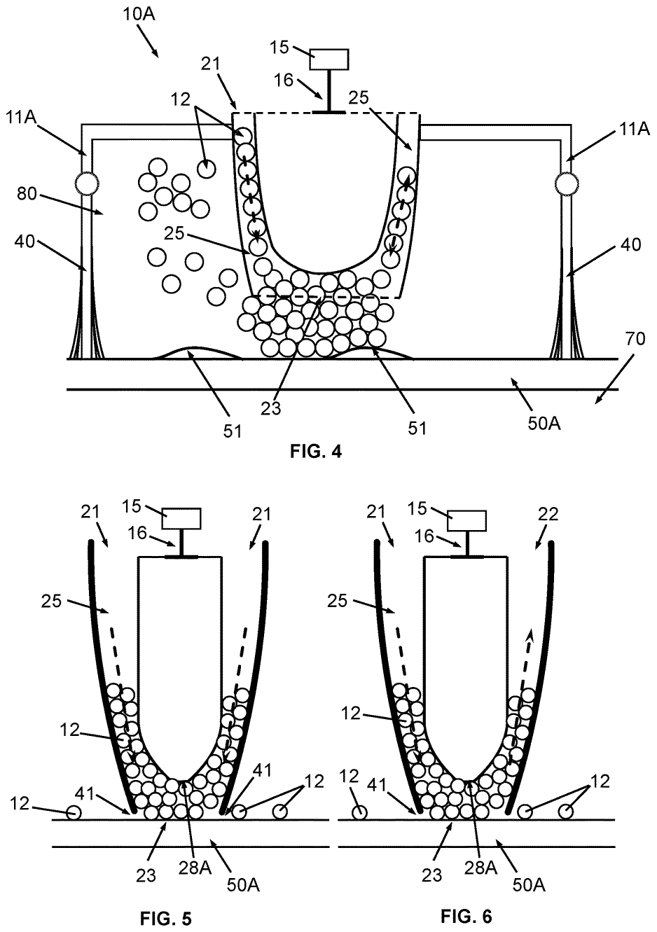

FIG. 4 shows, in a cross-section view, an electrolyte output device 10A of apparatuses conducting surface finishing in accordance with some embodiments.

The electrolyte output device 10A or the apparatus thereof has a housing 11A intended to form a closed chamber 80 between a base 70 or container, and the device 10A and/or the apparatus. The chamber 80 can be partially open by way of, e.g., at least one blocking device 40 of the device 10A or the apparatus that covers one or more openings between the housing 11A and the base or container 70, for example one or more brushes that are arranged to tightly block the passage of electrolyte 12 within the chamber 80 until sufficient pressure builds up therewithin, at which point the at least one blocking device 40 lets some electrolyte 12 escape.

The electrolyte 12 first gets into the chamber 80 owing to the flow of the electrolyte 12 from at least one inlet 21 through a conduit 25 coupled with the opening 23. An electrical source 15 electrically charges the device 10A and the electrolyte 12 by way of at least one electrode. As the electrolyte 12 reaches the opening 23, it may come into contact with a surface of a target object 50A and remove material from, for example, protrusions 51 or, occasionally, recesses on the surface of the target object 50A. The electrolyte 12 may, like in this example, go out from the device 10A and at least partially fill the chamber 80. As the electrolyte 12 moves within the chamber 80, it may reach other portions of the surface of the target object 50A or other surfaces not directly adjacent to the opening 23, thereby surface finishing those portions or surfaces as well.

To maintain the flow of new electrolyte 12, electrolyte 12 within the chamber 80 may partially exit it through the opening or openings between the housing 11A and the base or container as previously explained, namely, through the pressure on the at least one blocking device 40. Alternatively, in some cases, electrolyte 12 may exit through other openings or through another end of the conduit 25 as illustrated, for the sake of clarity only, with a dashed double-arrowed line on the right part of the conduit 25. The dashed double-arrowed line illustrates that such part of the conduit 25 may be used for the introduction of electrolyte or for the extraction of electrolyte.

FIG. 5 shows, in a cross-section view, an electrolyte output device of apparatuses conducting surface finishing in accordance with some embodiments.

The electrolyte output device has a conduit 25 arranged such that electrolyte 12 is introduced therein and routed towards the opening 23 from inlets 21 at both sides of the conduit 25 as illustrated with the dashed arrow lines.

The electrolyte output device may have, adjacent to the opening 23, at least one blocking device 41, such as a flexible device, a brush, or the like, that partially lets the electrolyte 12 exit the electrolyte output device as the electrolyte 12 surface finishes the target object 50A, which is for example a planar object.

FIG. 6 shows, in a cross-section view, an electrolyte output device of apparatuses conducting surface finishing in accordance with some embodiments.

The electrolyte output device has a conduit 25 arranged such that electrolyte 12 is introduced therein from an inlet 21 towards the opening 23, and then routed towards an outlet 22 as illustrated with the dashed arrow lines.

FIG. 7 shows, in a cross-section view, an electrolyte output device 10B of apparatuses conducting surface finishing in accordance with some embodiments.

The device 10B is part of an apparatus including a container 60B inside of which one or more target objects 50B are at least partially arranged. The target object 50B in this example is a chain with a plurality of chain links.

The container 60B may include a plurality of openings on a housing 11B thereof, such as one or more openings for the introduction of electrolyte 12 through an inlet 21, and one or more openings for the extraction of electrolyte 12 towards, e.g., an outlet 22 or out of the device 10B or apparatus completely. Concerning the latter, one or more blocking devices 40 such as brushes may be arranged for letting the electrolyte 12 exit only when there is sufficient electrolyte 12 within a closed chamber 80 of the container 60B.

Although not illustrated, a moving device is arranged for producing relative motion between the container 60B and the target object 50B. For example, the moving device may cause the target object 50B to move along the container 60B. To this end, the target object 50B, which may not be fully introduced in the container 60B at any point in time because it is longer than the container 60B, uses the openings blocked by the one or more blocking devices 40 for changing a portion of the target object 50B to be within the container 60B, either sequentially or continuously. Further, the moving device may also include a rotation device for rotating the target object 50B and, thus, expose different surfaces thereof to the surface finishing process.

One or more electrodes 28C may be arranged on an inner surface of the container 60B for the electrical charging of the electrolyte 12 and be coupled with the device 10B. The target object 50B is to be also electrically charged with opposite polarity for electropolishing to be achieved.

FIG. 8 shows an apparatus or an assembly 100A in accordance with some embodiments.

The apparatus or assembly 100A includes a plurality of stations, each station including either an apparatus or an electrolyte output device 10A. The apparatus or assembly 100A includes a moving device 70 shared between all that stations and which moves target objects on, e.g., a base 60A. The moving device 70, which may be a transport band, includes a reel winder 71 and a coil 72 for conveying target objects. The target objects may be part of the wound and coiled material, e.g., a film 50C.

FIG. 9 shows an apparatus or an assembly 100B in accordance with some embodiments.

The apparatus or assembly 100B includes a plurality of stations, each station including either an apparatus or an electrolyte output device 10A. In this example, the target objects 50A are wafers, which may be arranged on a base 60A in the form of a transport band, for example. A moving device moves the base 60A for the processing of different wafers.

Also, the apparatus or assembly 100B may include a pick and place device 75 configured to pick up wafers from a wafer storage 55 and place them onto the base 60A for surface finishing them.

The apparatuses or assemblies 100A, 100B may be configured in such a way that some stations processes (i.e., surface finishes) a portion already surface finished by another station, for example when first station or stations apply a coarse surface finishing and later station or stations apply a fine surface finishing. In some cases, each station processes a different portion of a target object such that the complete surface finishing of the target object is attained by the combination of the surface finishing by each station. Or, in other cases, each station processes a different target object, thereby providing a parallelized distributed surface finishing.

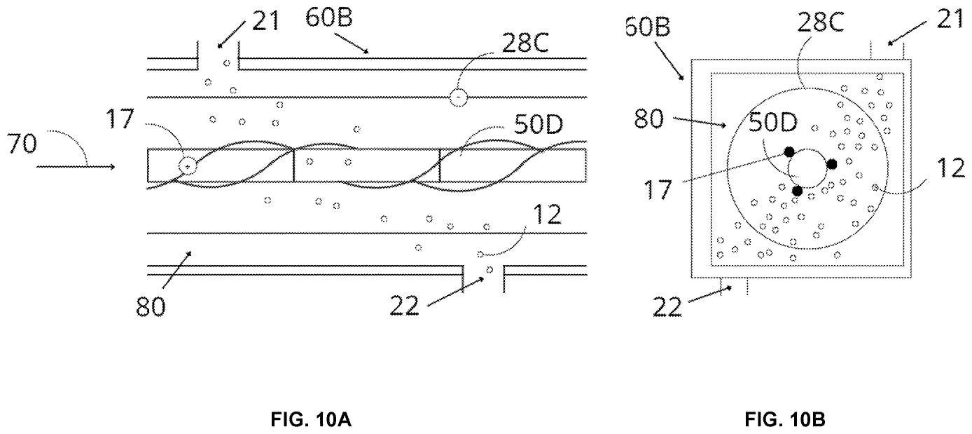

FIGS. 10A and 10B show a variant of an electrolyte output device for extrusion-shaped samples geometries, in accordance with some embodiments. FIG. 10A shows the electrolyte output device in a frontal cross-section view whereas FIG. 10B shows the electrolyte output device in a lateral cross-section view.

The example represented on FIGS. 10A and 10B, in some embodiments, is suitable for continuous the surface treating in series of parts presenting an extrusion geometry.

In these illustrated embodiments, the electrolyte output device comprises a housing container 60B adapted with an inlet 21 and an outlet 22 from where the electrolyte 12 is recirculated trough said housing container.

At an interior of the chamber 80, i.e., housing container, the electrolyte output device comprises a holding device 17 for holding a part (i.e., target object) to be treated and which is configured to follow an extrusion profile of the part 50D to be treated. The part 50D is held by or attached to the holding device 17, for example by being arranged inside the holding device 17. Other suitable holding devices for holding or attaching a part to be treated are possible as well, and they all are part of the present disclosure.

The holding device 17 can be either conductive or non-conductive depending on a selected configuration. In some embodiments, a pole of an electrical source 15 is connected to the one or more parts 50D to be surface treated or to the holding device 17 for applying a potential difference between the part and a conductive device 28C (e.g., electrodes), connected to a second pole of the electrical source 15, which is preferably arranged at a certain distance from the part 50D, and in electrical contact to the parts 50D through the electrolyte 12.

In some embodiments, the parts 50D are adapted to conveying means 70, allowing their circulation within a housing container 80 through a channel created by the holding device 17. A shape or geometry of the holding device 17 can be adapted in a way that an area of the part 50D that is not exposed to an electrolyte 12 changes along the moving direction in a way that there is no preferential polishing surface over all the surfaces to be treated, such as presenting a spiral shape in the case of treating a cylindrical part.

In this text, the term “includes”, “comprises” and derivations thereof (such as “including”, “comprising”, etc.) should not be understood in an excluding sense, that is, these terms should not be interpreted as excluding the possibility that what is described and defined may include further elements, steps, etc.

On the other hand, the disclosure is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. An apparatus configured to facilitate a flow of electrically conductive free solid bodies on a surface of a target object to surface finish the target object, the apparatus comprising:
a first housing having an open end that is configured to contact a part of a substrate to produce an at least partially closed chamber for receiving the electrically conductive free solid bodies, the first housing including a blocking device that is configured to permit an egress of at least some of the electrically conductive free solid bodies to outside the chamber upon a given pressure being exerted by the electrically conductive free solid bodies on the blocking device.

2. The apparatus according to claim 1, wherein the substrate is a part of the target object, at least a part of the blocking device is configured to abut the part of the target object.

3. The apparatus according to claim 2, wherein the first housing includes an inlet opening configured to facilitate an entry of the electrically conductive free solid bodies into the chamber.

4. The apparatus according to claim 3, wherein the first housing includes an outlet opening, other than the blocking device, that is configured to facilitate an egress of the electrically conductive free solid bodies from the chamber.

5. The apparatus according to claim 3, further comprising:
an electrode; and
a conduit located inside the first housing, the conduit being in fluid communication with the inlet opening and being formed at least in part by a side of the electrode.

6. The apparatus according to claim 1, further comprising:
an electrode; and
a second housing at least partially disposed inside the chamber of the first housing, the electrode at least partially residing inside the second housing, a first side of the second housing forming with a first side of the electrode a first conduit, a second side of the second housing forming with a second side of the electrode a second conduit, each of the first and second conduits having a first end open to an exterior of the first housing and a second end in fluid communication with an opening of the second housing adjacent the surface of the target object, each of the first and second conduits being configured to transport the electrically conductive free solid bodies.

7. The apparatus according to claim 1, wherein the blocking device comprises one or more elements selected from the group consisting of: elastically deformable devices, flexible devices and brushes.

8. The apparatus: according to claim 1, wherein the substrate is a base configured to support the target object.

9. The apparatus according to claim 8, wherein the blocking device is configured to abut the base.

10. The apparatus according to claim 8, wherein the first housing includes an inlet opening configured to facilitate an entry of the electrically conductive free solid bodies into the chamber.

11. The apparatus according to claim 10, wherein the first housing includes an outlet opening, other than the blocking device, that is configured to facilitate an egress of the electrically conductive free solid bodies from the chamber.

12. The apparatus according to claim 10, further comprising:
an electrode; and
a conduit located inside the first housing, the conduit being in fluid communication with the inlet opening and being formed at least in part by a side of the electrode.

13. The apparatus according to claim 8, further comprising
an electrode; and
a second housing at least partially disposed inside the chamber of the first housing, the electrode at least partially residing inside the second housing, a first side of the second housing forming with a first side of the electrode a first conduit, a second side of the second housing forming with a second side of the electrode a second conduit, each of the first and second conduits having a first end open to an exterior of the first housing and a second end in fluid communication with an opening of the second housing adjacent the surface of the target object, each of the first and second conduits being configured to transport the electrically conductive free solid bodies.

14. The apparatus according to claim 8, wherein the blocking part comprises one or more elements selected from the group consisting of: elastically deformable devices, flexible devices and brushes.

15. An apparatus configured to facilitate a flow of electrically conductive free solid bodies on a surface of a target object to surface finish the target object, the apparatus comprising:
a housing; and
an electrode at least partially disposed inside the housing;
a first side of the housing forming with a first side of the electrode a first conduit, a second side of the housing forming with a second side of the electrode a second conduit, each of the first and second conduits having a first end open to an exterior of the housing and a second end in fluid communication with a distal opening of the housing, each of the first and second conduits being configured to transport the electrically conductive free solid bodies;
the opening of the housing being at least partially defined by a displaceable part that is configured to be placed in proximity to the target object and to permit an egress of at least some of the electrically conductive free solid bodies to outside the housing upon a given pressure being exerted by the electrically conductive free solid bodies on the deformable part.

16. The apparatus according to claim 15, wherein the deformable part comprises one or more elements selected from the group consisting of: elastically deformable devices, flexible devices, brushes and porous members.

17. A method of treating a surface of a target object with electrically conductive free solid bodies, the method comprising;
introducing the electrically conductive free solid bodies into a chamber defined by a housing having an opening located adjacent to the surface of the target object;
causing the electrically conductive free solid bodies to flow across the surface of the target object while applying a potential difference between the electrically conductive free solid particles and the target object; and
the housing including a blocking device that is configured to permit an egress of at least some of the electrically conductive free solid bodies to outside the chamber upon a given force being exerted by the electrically conductive free solid bodies on the blocking device, the method further comprising imparting the given force to the blocking device to expel the at least some of the electrically conductive free solid bodies from the chamber.

18. The method according to claim 17, wherein a distance between the opening of the housing and the surface of the target object is maintained between 0.1 millimeters and 20 millimeters.

19. The apparatus according to claim 17, wherein the blocking device comprises one or more elements selected from the group consisting of: elastically deformable devices, flexible devices and brushes.

20. The method according to claim 17, wherein the electrically conductive free solid bodies comprise materials selected from the group consisting of: chelating resins, acidic cationic resins and anion exchange resins.
